(19) United States
(12) Patent Application Publication
(10) Pub. No.: US 2008/0169407 A1
(43) Pub. Date: Jul. 17, 2008

(54) TREE MOUNTED QUIVER SUPPORT

(76) Inventor: JAMES E. BROBERG, Crystal Lake, IL (US)

Correspondence Address: Mathew R. P. Perrone, Jr.;Brie A. Crawford, 210 South Main Street, Algonquin, IL, 60102, US

(21) Appl. No.: 11/623,226

(22) Filed: Jan. 15, 2007

(51) Int. Cl. F16M 13/02

(52) U.S. Cl. 248/544

(57) ABSTRACT

A quiver support has a housing with a U-shaped member. At the base of the U-shaped member is a threaded member or other mounting device, preferably on a rear portion of the quiver support. A quiver holder extends from the U-shaped member and receives the quiver in two co-axial slotted arms.

This invention relates to a tree mounted quiver support and more particularly to a tree mounted quiver support, which may be easily attached to a tree and then removed from the tree, when the hunting time is complete.

### BACKGROUND OF THE INVENTION

In the course of a hunting season, many devices may be used by a hunter. This is especially true for a bow and arrow hunter or an archer who hunts. It is very common for a hunter to use a tree as an equipment support. Whether the hunter climbs the tree or hangs equipment on the tree, or both, a tree is used by a hunter.

However, a tree does not always have convenient or efficient positions, from which equipment may be placed or hung. Additionally, equipment can snag on the bark of a tree. This is especially true for an archer. Either the quiver of arrows or the arrows themselves may become snagged on the bark of a tree. Thus, it is desirable to have a device, which can minimize these problems.

More particularly, when the hunter is an archer, it is very convenient to have an appropriate place to support both the arrows and the quiver. To that end, it is useful to have a device which may be easily attached to and removed from the tree. It is also useful for that device to be easily transportable. In this fashion, a hunter may have the quiver and arrows easily accessible in order to provide a pleasant hunting experience. If such a device can be developed, the hunter, as an archer has better use of his equipment.

### SUMMARY OF THE INVENTION

Among the many objectives of this invention, is to provide an easily transported device adapted to support a quiver and the arrows in a desired position.

A further objective of this invention is the provision of a device to hold a quiver of arrows in a desired position.

Yet a further objective of this invention is the provision of a device to a set of arrows in a desired position.

These and other objectives of the invention (which other objectives become clear by consideration of the specification, claims and drawings as a whole) are met by providing a quiver support capable of being easily mounted on and removed from a tree.

### BRIEF DESCRIPTION OF THE DRAWINGS

FIG. 1 depicts a perspective view of quiver support 100 of this invention attached to a tree 102.

FIG. 2 depicts a perspective view of quiver support 100 of this invention with quiver 104 therein.

FIG. 3 depicts a perspective view of quiver support 100 of this invention.

FIG. 4 depicts a front plan view of quiver support 100 of this invention.

FIG. 5 depicts a back view of quiver support 100 of this invention.

FIG. 6 depicts a right side view of quiver support 100 of this invention.

FIG. 7 depicts a left side view of quiver support 100 of this invention as a reverse view of FIG. 6.

FIG. 8 depicts a top view of quiver support 100 of this invention with quiver strap 124 in an open position 180.

FIG. 9 depicts a top view of quiver support 100 of this invention with quiver strap 124 in a closed position 190.

FIG. 10 depicts a block diagram of quiver support 100 of this invention.

Throughout the figures of the drawings, where the same part appears in more than one figure of the drawings, the same number is applied thereto.

### DESCRIPTION OF THE PREFERRED EMBODIMENTS

A quiver support has a housing with a U-shaped base. On the outside of the U-shaped base is a threaded member or other mounting device, preferably on a rear portion of the quiver support. Extending upwardly from the base are two side panels. From each side panel, extends the quiver holder. Each panel of the quiver support is generally rectangular. A strap releasably holds the quiver in a desired position.

From each side panel extends a support arm, which is substantially perpendicular to each side panel. From each support arm extends a slotted arm substantially perpendicular to its respective side panel. Within each of the slotted arm is a quiver slot which is V-shaped. The similarity of the slots permits the quiver to be positioned therein and held in place by the quiver strap.

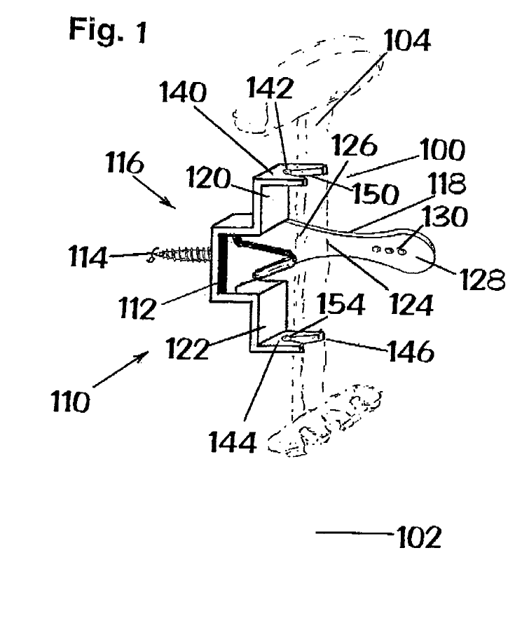

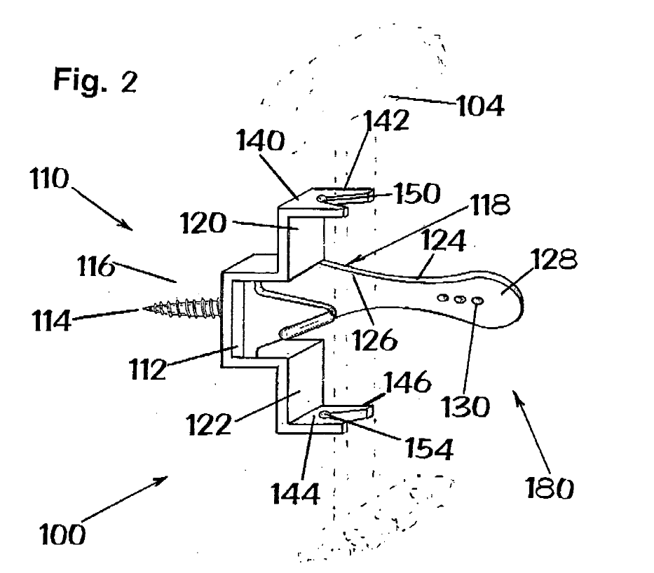

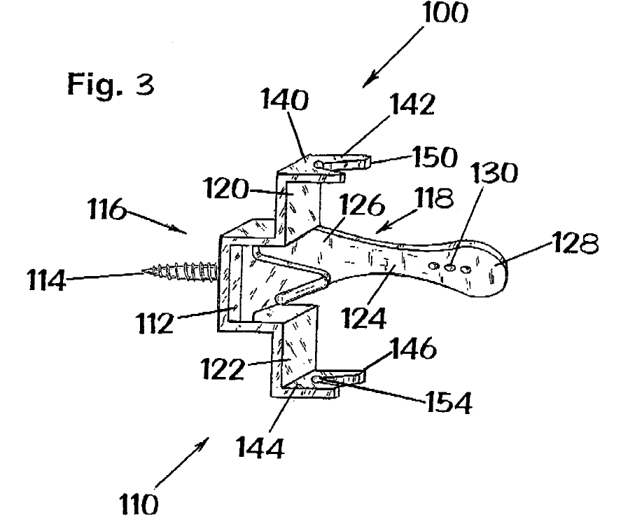

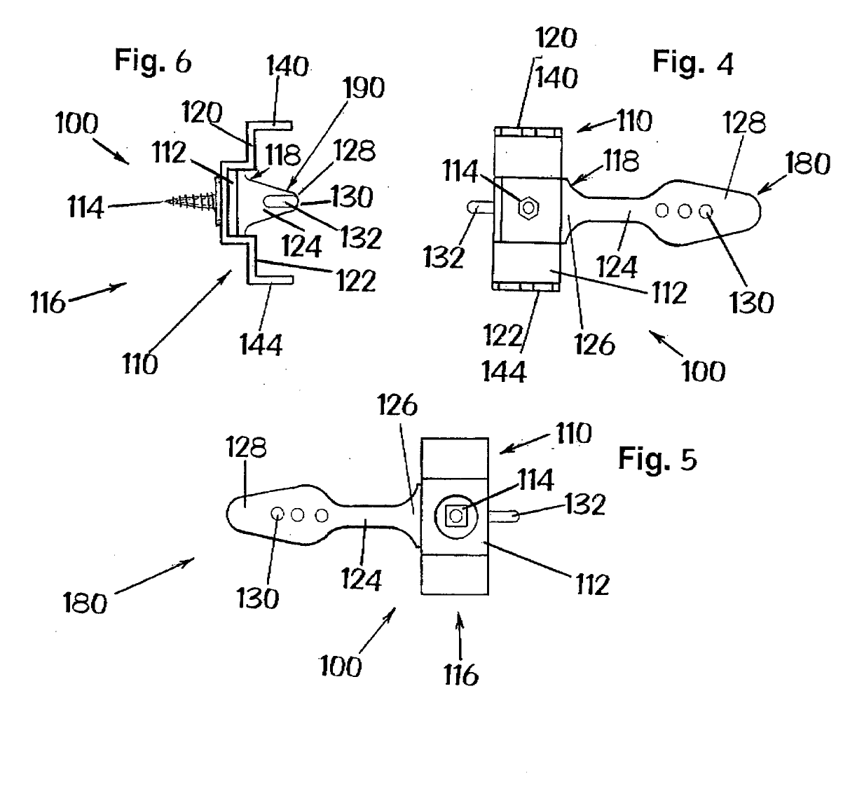

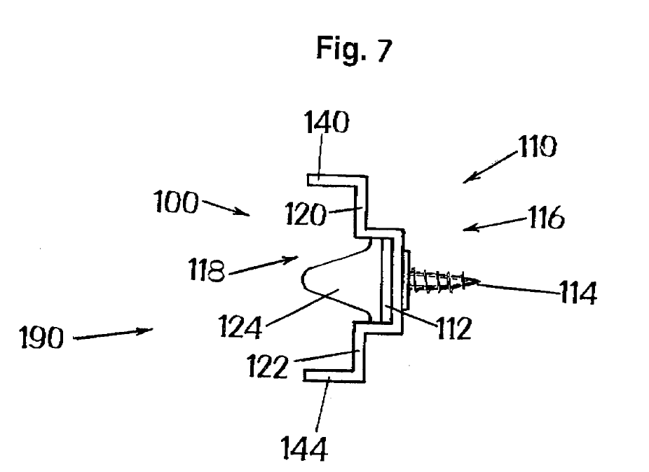

Referring now to FIG. 1, FIG. 2, FIG. 3, FIG. 4, FIG. 5, FIG. 6, and FIG. 7, the structure and the use of quiver support 100 can be clearly seen. Housing 110 of quiver support 100 has unshaped base 112, with a mounting screw 114 thereon with a nut and bolt, welded or secured otherwise thereto, on the tree side 116 of the unshaped base 112. From the inner side 118 of the u-shaped base 112, protrudes upper arm 120 and a lower arm 122.

Secured to inner side 118 is a quiver strap 124. Quiver strap 124 has a fixed end or strap base 126, which is secured to inner side 118. Extending from strap base 126 on quiver strap 124 at a release end is a fastening member 128 with fastening apertures 130 therein. Oppositely disposed from fastening member 128, is fastening post 132. As the quiver 104 is inserted in the quiver support 100, quiver strap 124 is wrapped therearound with one of the fastening apertures 130 placed over fastening post 132, in order to secure quiver 104 therein.

Extending from upper arm 120 and oppositely disposed from the inner side 118 of the unshaped base 112 is the quiver holder 138. Quiver holder 138 has an upper platform 140. Upper platform 140 then extends into an upper slotted member 142. Extending from lower arm 122 oppositely disposed from the inner side 118 of the unshaped base 112 is a lower platform 144. Lower platform 144 then extends into a lower slotted member 146.

Upper slotted member 142 includes an upper quiver arm slot 150 to receive quiver 104. Lower slotted member 146 includes a lower quiver arm slot 154 to also receive quiver 104. At each end of quiver 104 are standard arrow holders 106. Quiver strap 124 fastens quiver 104 into upper quiver arm slot 150 and lower quiver arm slot 154.

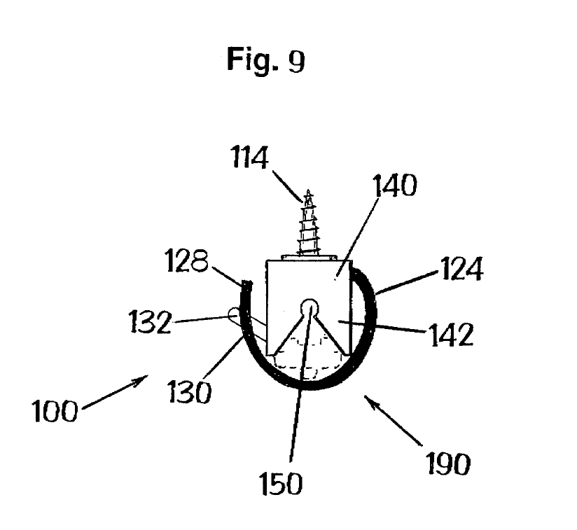

Lower platform 144 and upper platform 140 are preferably substantially coplanar. Upper slotted member 142 and lower slotted member 146 are substantially parallel and provide leverage for forcing mounting screw 114 (FIG. 9) into tree 102 for the mounting of quiver 104 thereon.

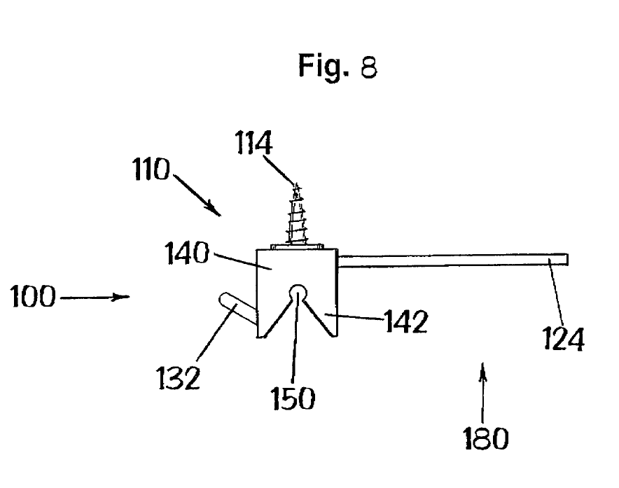

Adding FIG. 8 and FIG. 9 to the consideration, various positions of quiver strap 124 can be clearly seen. In FIG. 8 quiver strap 124 is in open position 180 and quiver support 100 is ready to accept quiver 104. In FIG. 9, quiver strap 124 is in closed position 190. In closed position 190, quiver 104 is securely held in place through the cooperation of fastening aperture 130 and fastening post 132.

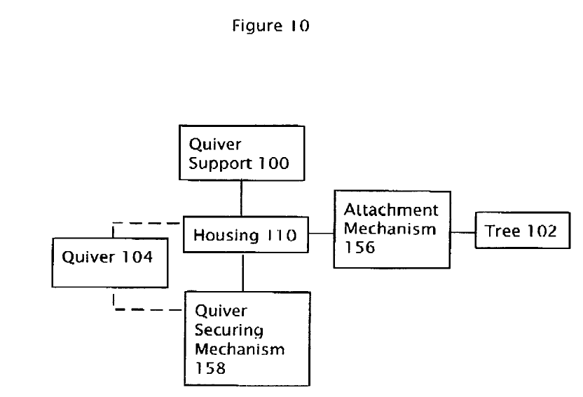

Adding FIG. 10 to the consideration, various modifications to quiver support 100 can clearly be seen. Quiver support 100 has housing 110 which can be any shape or arrangement so long as it provides support for quiver 104. On housing 110 is attachment mechanism 156, such as screw 114 in FIG. 9 which forms a secure attachment with tree 102. In the previous embodiments, attachment mechanism 156 was mounting screw 114 but a strap, hook and loop assembly, a snap assembly, a clip assembly or any other suitable device may be attachment mechanism 156.

On the inner side of housing 110 is quiver securing mechanism 158. In the preferred embodiment is quiver strap 124 and fastening post 132. However quiver securing mechanism 158 can be a strap, hook and loop assembly, a snap assembly, a clip assembly or other suitable device.

This application—taken as a whole with the specification, claims, abstract, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this method and apparatus can become clear to a person having ordinary skill in this particular art. Such modifications are clearly covered by this disclosure.

What is claimed and sought to be protected by Letters Patent of the United States is:

1. A quiver support capable of being easily mounted on and removed from a tree comprising:
a) the quiver support having a housing, a strap and a mounting device;
b) the housing including a U-shaped member;
c) the U-shaped member including the mounting device; and
d) a quiver holder extending from the U-shaped member.

2. The quiver support of claim 1 further comprising:
a) the U-shaped member having a base, a first side panel and a second side panel;
b) the base have the first side panel and the second side panel on opposing sides thereof;
c) the base member including the mounting device;
d) the quiver holder extending from the first side panel and the second side panel; and
e) the first side panel and the second side panel being oppositely disposed from the mounting member.

3. The quiver support of claim 2 further comprising:
a) the quiver holder having a first support arm extending from the first side panel;
b) the quiver holder having a second support arm extending from the second side panel;
c) the first support arm having a first slotted arm extending from the first support arm and oppositely disposed from the first side panel; and
d) the second support arm having a second slotted arm extending from the second support arm and oppositely disposed from the second side panel.

4. The quiver support of claim 3 further comprising:
a) the first slotted arm including a first quiver slot; and
b) the second slotted arm including a second quiver slot;
c) the first quiver slot and the second quiver slot being adapted to receive the quiver;
d) the strap being adapted to releasably secure the quiver in position; and
e) the mounting member being adapted to secure the quiver support in a desired position.

5. The quiver support of claim 4 further comprising:
a) the first quiver slot and the second quiver slot each being V-shaped;
b) the first quiver slot and the second quiver slot having a common axis; and
c) the mounting member being a screw adapted to fit into a tree; and
d) the first slotted arm and the second slotted arm providing leverage for inserting or removing the screw.

6. The quiver support of claim 5 further comprising:
a) the quiver support being generally rectangular;
b) the strap being secured at a fixed end to the base member; and
c) the strap being releasably securable to the base member at a release end; and
d) the strap cooperating with the first slotted arm and the second slotted arm to secure the quiver in the quiver holder.

7. The quiver support of claim 6 further comprising:
a) the release end of the strap having apertures therein;
b) a fastening post being secured to the base member opposite the release end;
c) the fastening post being adapted to receive one of the apertures as desired.

8. The quiver support of claim 6 further comprising the strap release end including a hook and loop assembly, a snap assembly, or a clip assembly.
